(19) United States
(12) Patent Application Publication
(10) Pub. No.: US 2026/0302699 A1
(43) Pub. Date: Oct. 1, 2026

(54) COAXIAL CABLE ASSEMBLY WITH VIDEO AND SWITCH CONTACTS

(71) Applicant: ITT Cannon LLC, Irvine, CA (US)

(72) Inventor: Michael Santos FINONA, Fountain Valley, CA (US)

(73) Assignee: ITT Cannon LLC, Irvine, CA (US)

(21) Appl. No.: 19/559,720

(22) Filed: Mar. 6, 2026

Related U.S. Application Data
(60) Provisional application No. 63/777,742, filed on Mar. 26, 2025.

(51) Int. Cl. H01R 24/46; H01R 24/28; H01R 24/56

(52) U.S. Cl. CPC H01R 24/46; H01R 24/28; H01R 24/562; H01R 24/568; H01R 2201/18; H01R 2201/24

(57) ABSTRACT

A cable assembly includes a coaxial, three-wire, triaxial, or similar cable with coaxial or triaxial connectors coupled to both termini and a control switch. The control switch is used to enable or disable video signal transmission through the cable assembly. A control signal from the switch is transmitted via a center conductor of the coaxial or triaxial cables or a single wire of the three-wire cable. Video signal or similar RF signals are transmitted through the shields or twisted wire pair.

### CROSS REFERENCE TO RELATED APPLICATIONS

This application claims priority to U.S. Provisional Patent Application Ser. No. 63/777,742 filed on March 26, 2025. The disclosures of the Provisional Application are hereby incorporated by reference in their entirety.

### BACKGROUND

Unless otherwise indicated herein, the materials described in this section are not prior art to the claims in this application and are not admitted as prior art by inclusion in this section.

Coaxial cables are used as a transmission line for signals in radio frequency (RF) range. Coaxial cables may be used to connect radio transmitters and receivers to their antennas, computer networks connections, digital audio (S/PDIF), and distribution of cable television signals. While coaxial cables may be used to provide high bandwidth signals, their center conductor – shield construction limits certain applications that may require an additional signal or control line.

### SUMMARY

The present disclosure generally describes a coaxial cable assembly configuration with video and switch contacts.

According to some examples, a coaxial cable assembly may include a coaxial cable comprising three conductors; a first connector coupled to a first terminus of the coaxial cable comprising at least three contacts; and a second connector coupled to a second terminus of the coaxial cable comprising at least three contacts, where two of the three conductors and two of the at least three contacts of the first and second connectors are used to transmit a radio frequency (RF) signal, and one of the three conductors and one of the at least three contacts of the first and second connectors are used to transmit a control signal.

According to other examples, a triaxial cable assembly may include a triaxial cable comprising a center conductor, a first shield, and a second shield; a first triaxial connector coupled to a first terminus of the triaxial cable comprising a center conductor, a first shield, and a second shield; a second triaxial connector coupled to a second terminus of the coaxial cable comprising a center conductor, a first shield, and a second shield; and a control switch. The first shield and the second shield of the triaxial cable, the first triaxial connector, and the second triaxial connector may be used to transmit a video signal, and the center conductor and one of the first and second shields of the triaxial cable, the first triaxial connector, and the second triaxial connector may be used to transmit a control signal from the control switch.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A and 1B schematically illustrate layers of two coaxial cable configurations with video and switch contacts;

FIG. 2A and 2B illustrate a side view and a top view of a coaxial cable assembly with video and switch contacts;

FIG. 3A and 3B schematically illustrate a conventional coaxial cable and a coaxial cable assembly with video and switch contacts;

FIG. 3C illustrates the switch and coaxial cable connection in a coaxial cable assembly with video and switch contacts;

FIG. 4A illustrates side, perspective, and front views of a triaxial plug connector for a coaxial cable assembly with video and switch contacts;

FIG. 4B illustrates a cross-section view of a triaxial plug connector for a coaxial cable assembly with video and switch contacts;

FIG. 4C illustrates side, perspective, and front views of a triaxial receptacle connector for a coaxial cable assembly with video and switch contacts;

FIG. 4D illustrates a cross-section view of a triaxial receptacle connector for a coaxial cable assembly with video and switch contacts;

FIG. 5 illustrates the connectors and the switch of a coaxial cable assembly with video and switch contacts; and

FIG. 6 illustrates a front view with contact layout of an example multi-pin connector that may be used with a coaxial cable assembly with video and switch contacts,

arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and/or devices related to a coaxial cable assembly with video and switch contacts.

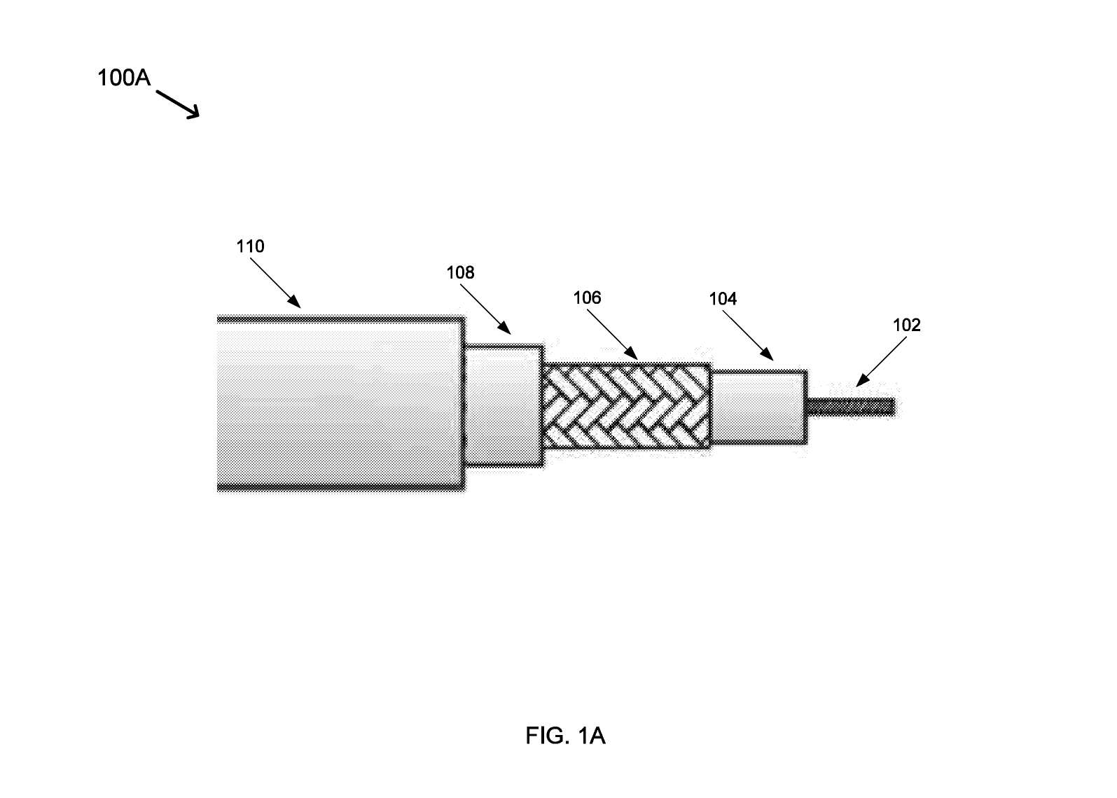

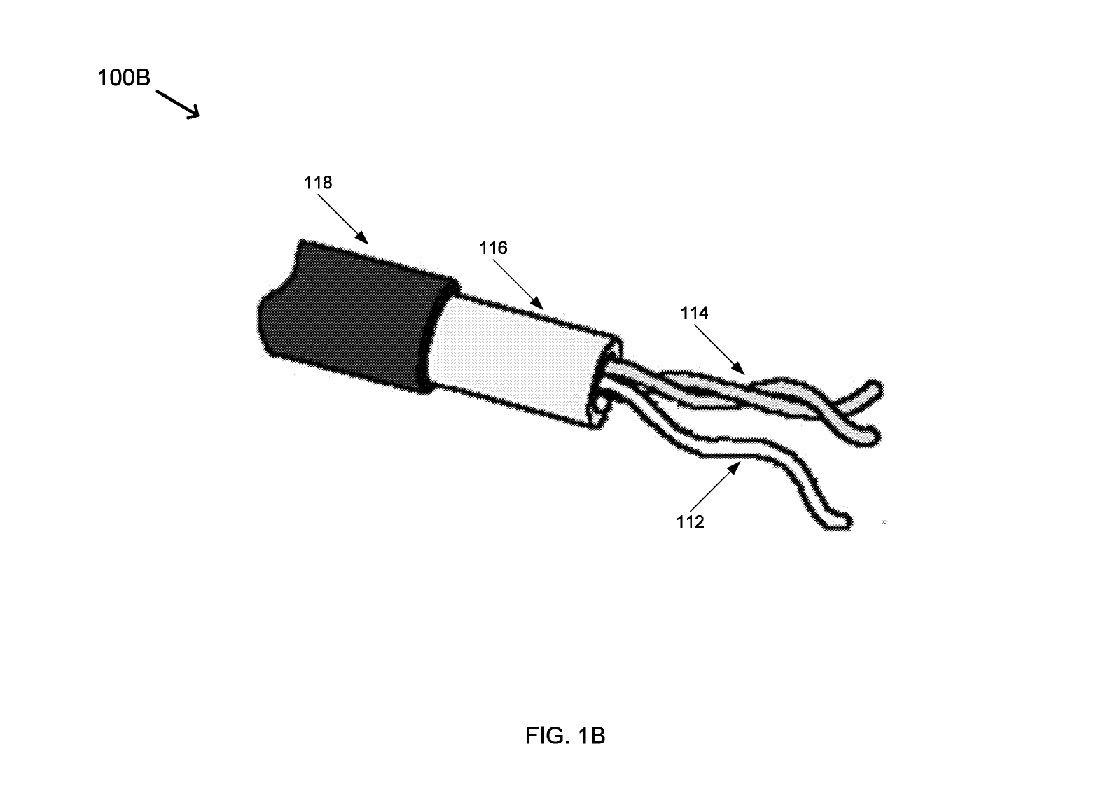

FIG. 1A and 1B schematically illustrate layers of two coaxial cable configurations with video and switch contacts, arranged in accordance with at least some embodiments described herein.

Diagram 100A shows one example configuration of a coaxial cable according to examples with center conductor 102, insulator 104, shield 106, second insulator 108, and conductive outer body 110. In this configuration, the video signal may be transmitted over the shield 106 and conductive outer body 110 while a turn on/off control signal may be sent over the center conductor 102.

Diagram 100B shows another example configuration of a coaxial cable according to examples with a single wire 112 for control signal, twisted wire pair 114 for video signal, shield 216 covering all three wires, and an outer insulator 118. In this configuration, the video signal may be transmitted over the twisted wire pair 114 while the turn on/off control signal may be sent over the single wire 112.

“Coaxial” in a coaxial cable refers to the geometric axis the shield and the inner conductor share. Unlike simple shielded cables transmitting low-frequency signals, coaxial cables offer superior transmission and reception capabilities, conducting alternating currents of radio frequency (RF). The central conductor transmits RF signals, with the shield layer acting as return. The dielectric insulator ensures that the spacing between the conductor and the shield layer remains consistent for the full cable length providing consistent impedance. Additionally, the conducting shield layer safeguards signals against EMI and signal loss, creating a magnetic field with the conductor.

Some coaxial cables may be constructed using copper, silver, aluminum, nickel, or steel for the center conductor and one of these materials for a shield. These thick cables (≥ ½-inch diameter) may be used for high-strength transmission in applications such as military signals or broadcasting radio between a ground-level transmitter and an antenna or aerial receiver. While many types of connectors may be used with coaxial cables, example implementations may utilize Bayonet Neil-Concelman (BNC) connectors, Threaded Neil-Concelman (TNC) connectors, Subminiature version B (SMB) connectors, Quick mating subminiature version A (QMA) connectors, 7/16 Deutsches Institut für Normung (DIN) connectors, Micro coaxial (MCX) connectors, Radio Corporation of America (RCA) connectors, and similar ones.

One of the example environments for coaxial cable use are night vision or augmented reality (AR) goggles, where video signals may be provided to the goggles from a body-worn controller or similar device or video captured by the night vision glasses may be provided to the body-worn device from the glasses. In such scenarios, a user may need to control the video signal, for example, turn it on or off. In conventional systems, such control signals are provide through another cable or a non-coaxial cable is used for the entire connection. In addition to night vision or AR goggles, a coaxial cable with video and switch control may be used in conjunction with any form of display and video source, as well as, any form of video capture device and connected processing, storage, or display device.

Example implementations allow control of video signal (or any other signal) by using the center conductor of the coaxial cable to provide the control signal and the shield and conductive outer body to provide the video signal. In the example of night vision goggles and AR/VR goggles, the control signal through the center conductor may be used to turn on or off the video signal transmitted through the shield and conductive outer body of the coaxial cable and connectors.

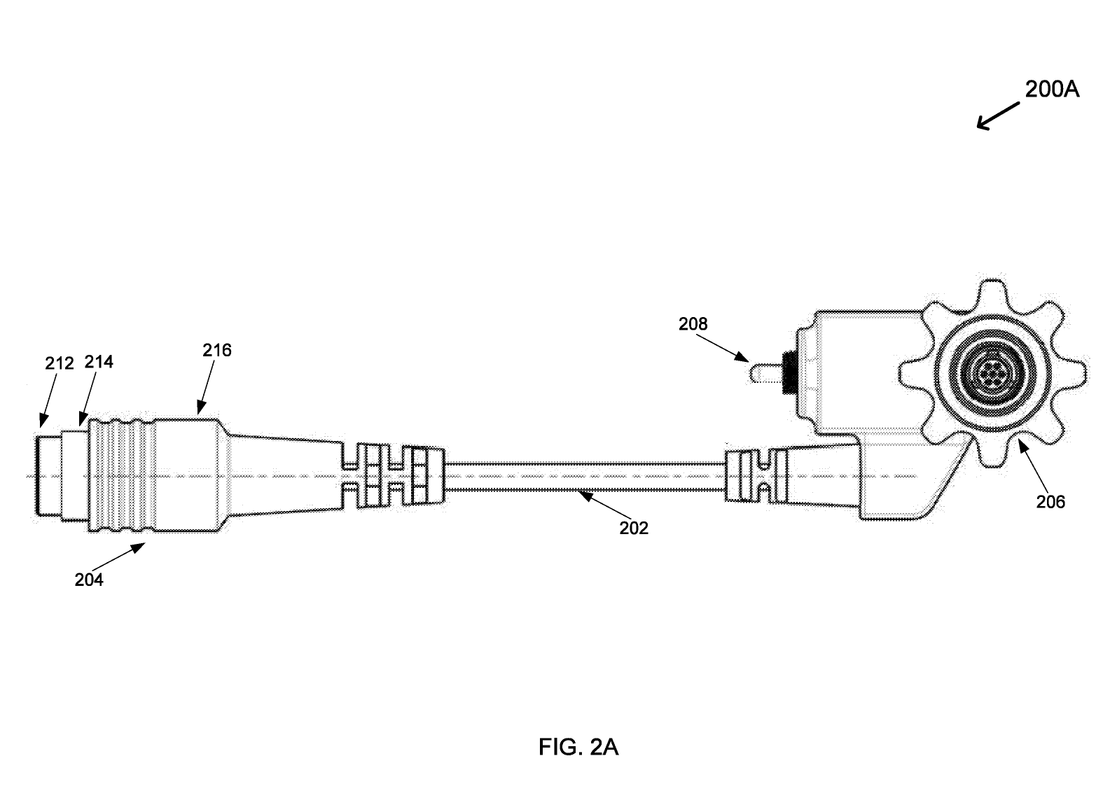

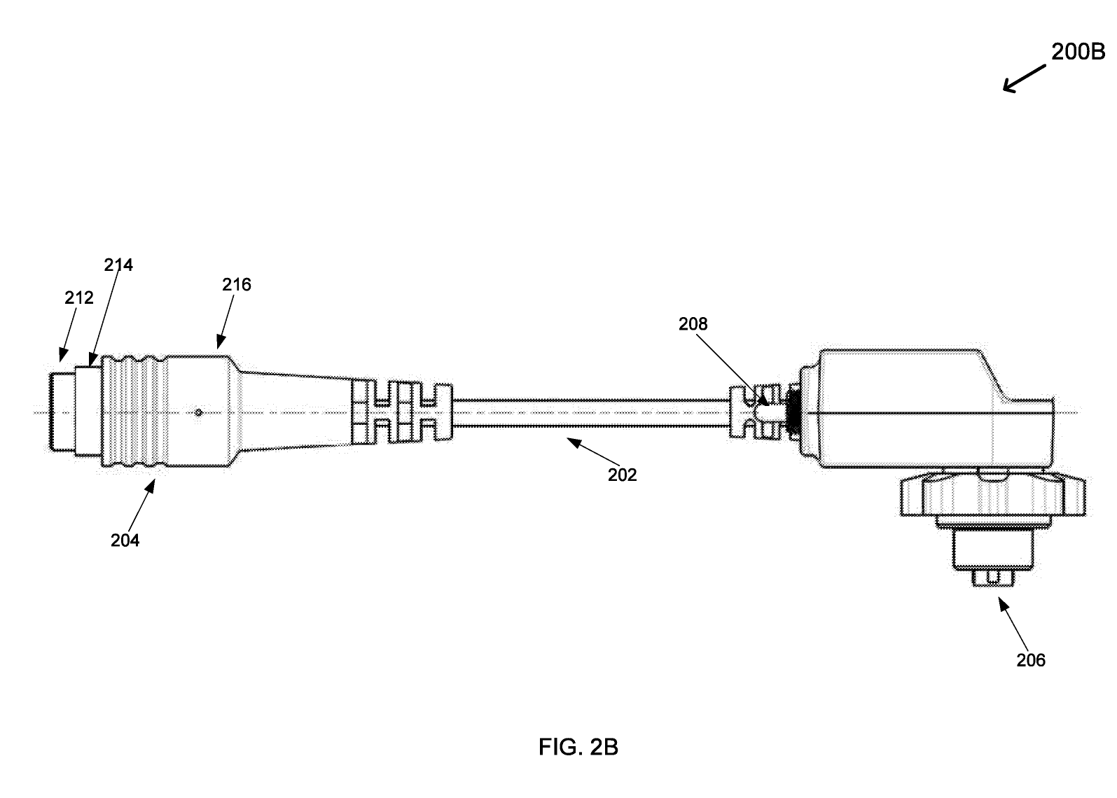

FIG. 2A and 2B illustrate a side view and a top view of a coaxial cable assembly with video and switch contacts, arranged in accordance with at least some embodiments described herein.

Diagrams 200A and 200B show side and top views of a coaxial cable assembly according to examples with coaxial cable 202, first coaxial connector 204, second coaxial connector 206, and control switch 208. The first coaxial connector 204 may include a center conductor (not shown), shield 212, conductive outer body 214, and insulator shell 216. Insulators between the center conductor and shield, and between the shield and the conductive outer body are not shown. The second coaxial connector 206 may be similar or different. For example, a multi-pin coaxial connector may be used with only three of the pins being active (two for video and one for control). The control switch 208 may be any electro-mechanical control element such as a push-button switch, a toggle switch, a rocker switch, a touch switch, etc. to enable or disable the video signal transmission.

A coaxial cable assembly according to examples may provide EMI protection against outside sources, signal protection against outside sniffing, reduced complexity, and increased robustness by using a single coaxial cable and associated connectors for video signal transmission and control signal transmission. For example, in military applications such as night vision goggles, EMI protection and robustness are critical aspects. The cables may be subject to sudden pulls and other forces. By using a single cable, the reduced complexity may increase the robustness of the assembly compared to multi-cable more complicated configurations.

While examples are described using video signal exchange and turn on/off (enable/disable) control signal exchange, any type of RF signal and any type of control signal may be exchanged over a coaxial cable assembly as described herein. For example, digital signals may be transmitted of the shield / conductive outer body pair (or twisted wire pair) and an end device detection signal may be exchanged over the center conductor (or single wire).

Furthermore, the shield / conductive outer body and twisted pair – single wire configurations discussed herein are example implementations. Other wire configurations in a coaxial cable structure may also be implemented using the principles described herein.

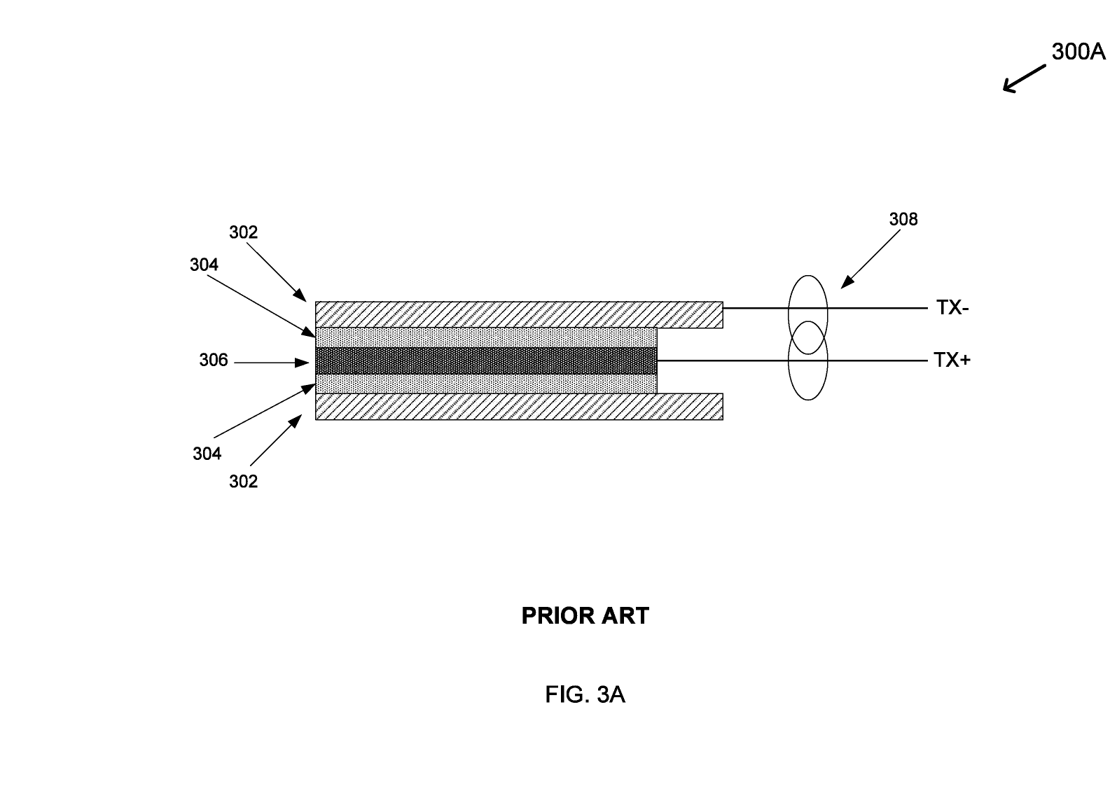

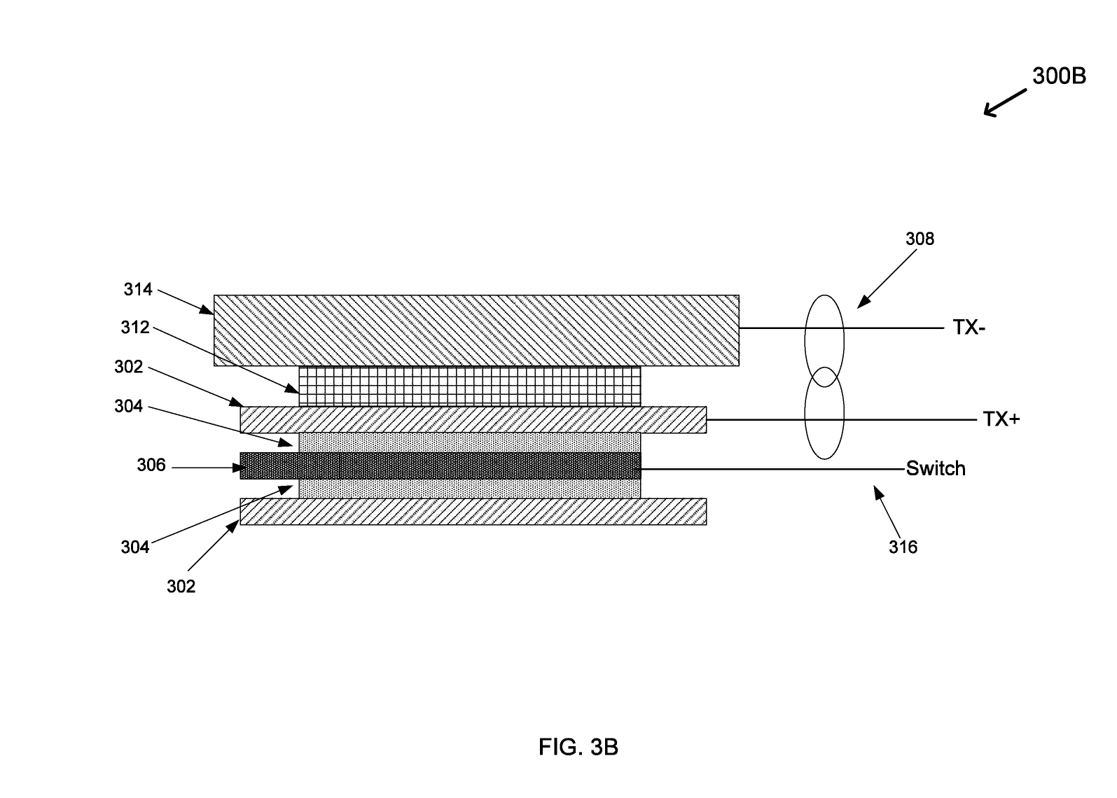

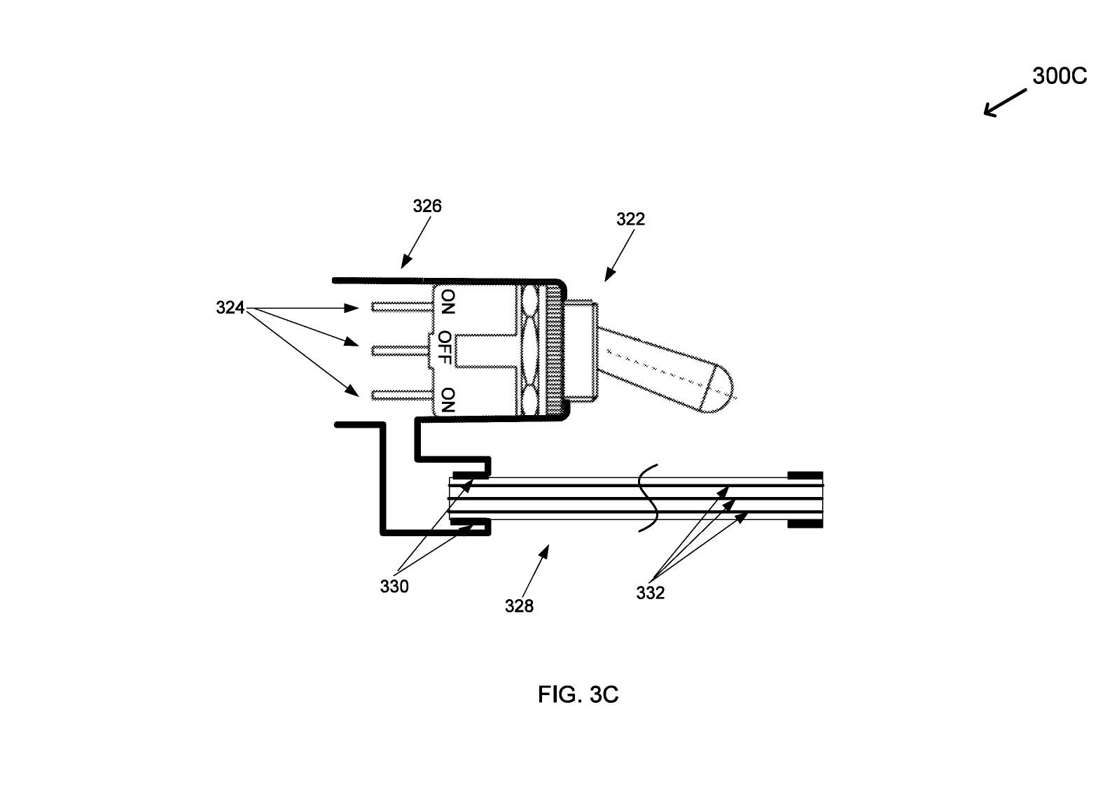

FIG. 3A and 3B schematically illustrate a conventional coaxial cable and a coaxial cable assembly with video and switch contacts, arranged in accordance with at least some embodiments described herein.

Diagram 300A shows a typical coaxial cable structure with a center conductor 306 surrounded by an insulator 304, and the insulator 304 surrounded by a shield 302, where the center conductor 306 and the shield 302 carry a differential signal (e.g., video signal). In some cases, the shield 302 may also be covered by a protective insulator layer.

Diagram 300B shows a coaxial cable structure according to examples with the center conductor 306 surrounded by an insulator 304, the insulator 304 surrounded by a shield 302, the shield 302 surrounded by another insulator 312, and the other insulator 312 surrounded by a conductive body 314. The differential signal is carried by the conductive body 314 and the shield 302, which may be arranged to present 75 ohm standard impedance in some examples. The center conductor 306 is used to carry a switch control signal 316, which may be an ON/OFF signal, an analog signal, or a digital signal (e.g., serial) to control transmission and/or other characteristics of the video signal and managed by a switch as discussed herein.

FIG. 3C illustrates the switch and coaxial cable connection in a coaxial cable assembly with video and switch contacts, arranged in accordance with at least some embodiments described herein.

Diagram 300C shows the control switch 322 and coaxial cable 328 of the example coaxial cable assembly. The control switch 322 may be any electro-mechanical control element such as a push-button switch, a toggle switch, a rocker switch, a touch switch, etc. to enable or disable the video signal transmission. The control switch’s contacts 324 indicating on or off state may be connected to the center conductor and the shield of the coaxial cable 328 or they may be connected to the shield and single wire of a three-wire coaxial cable with the twisted pair carrying the video signal. The coaxial cable 328 may include a center conductor and a shield or three wires (332) depending on configuration. A conductive body 330 may be connected to a shield or conductive cover over the switch not only providing EMI shielding, but also providing a return path for the control and/or video signal.

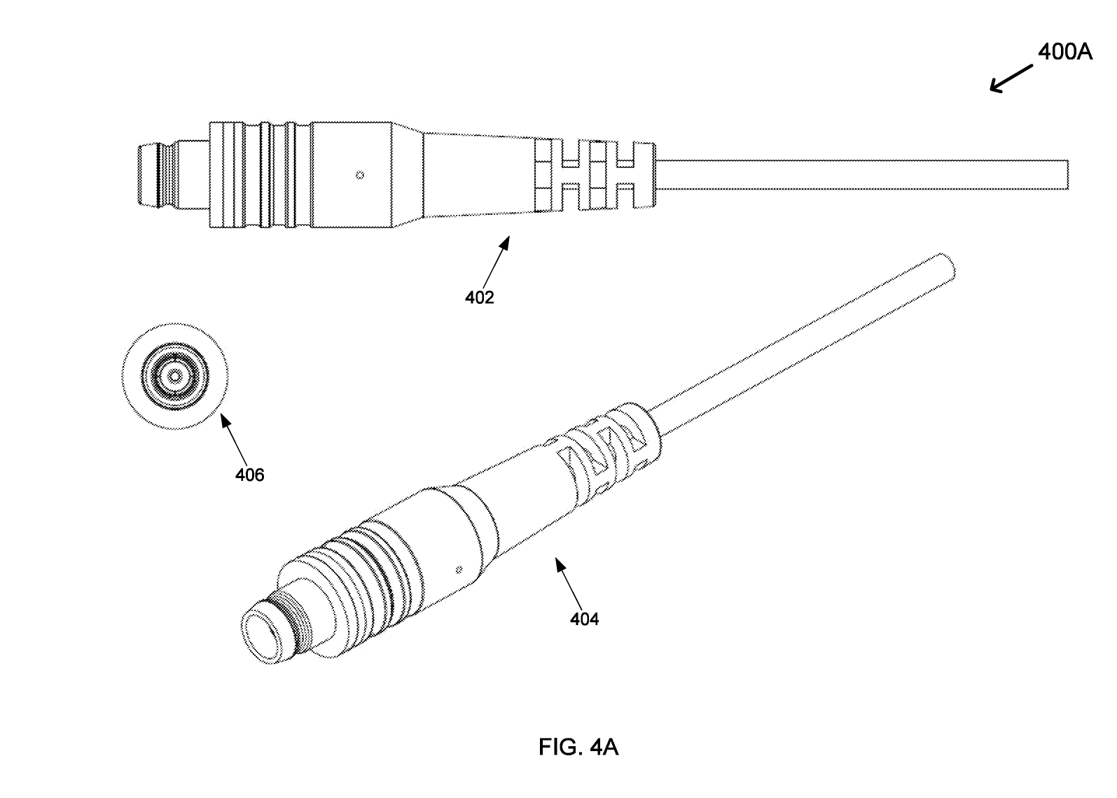

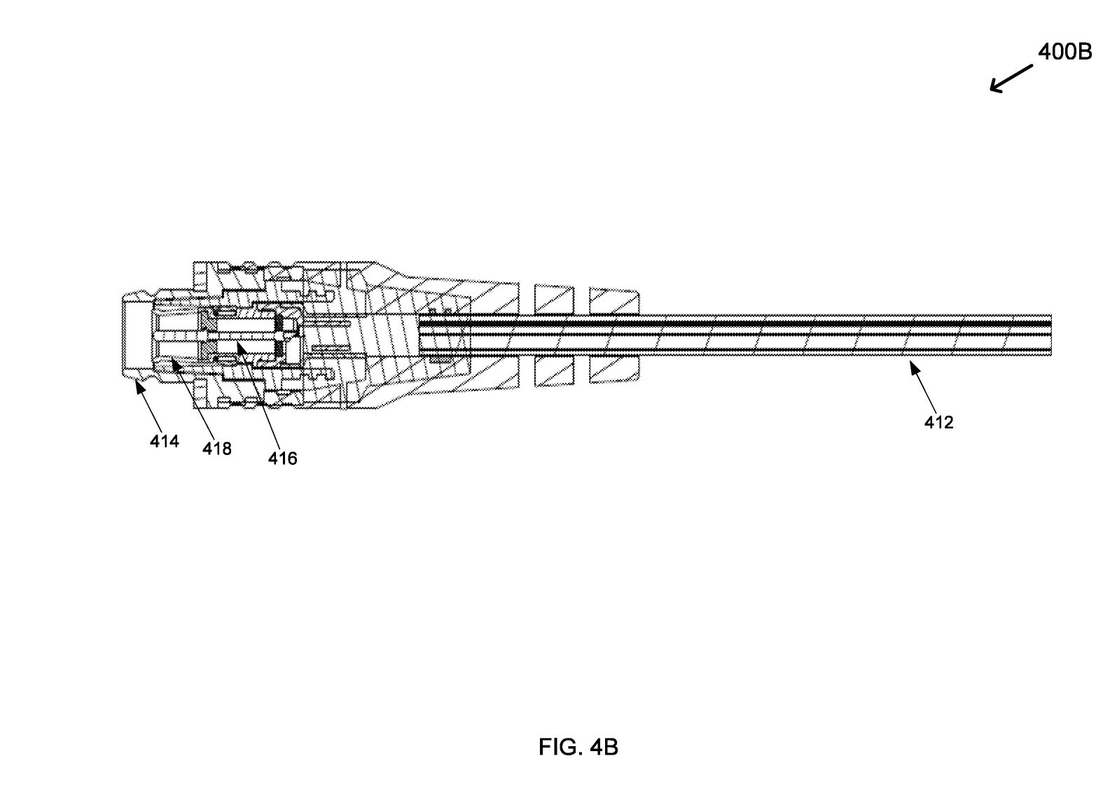

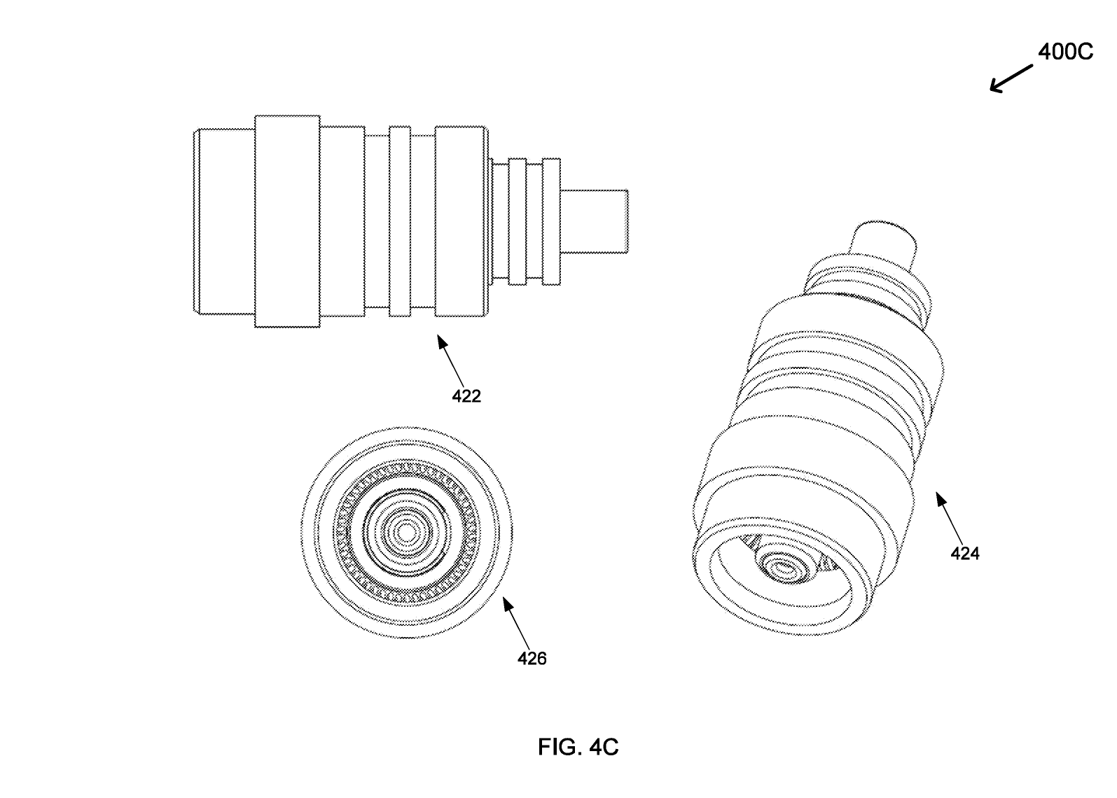

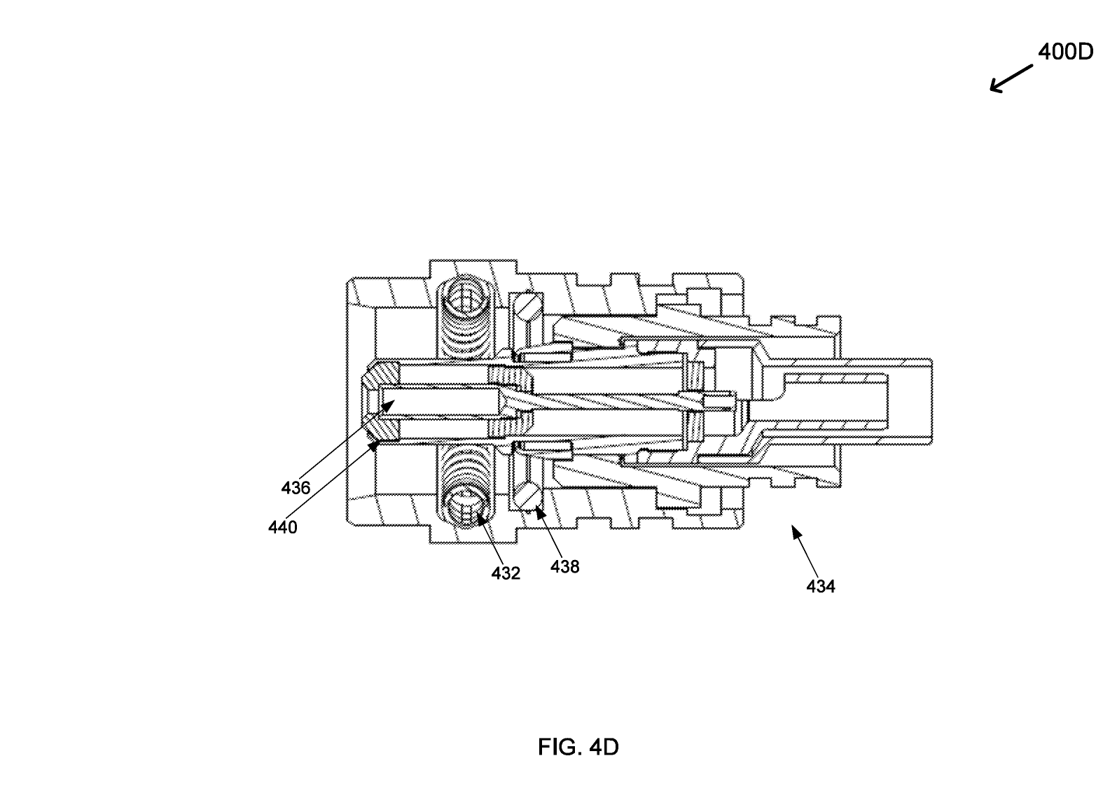

FIG. 4A illustrates side, perspective, and front views of a triaxial plug connector for a coaxial cable assembly with video and switch contacts, arranged in accordance with at least some embodiments described herein.

In addition to the standard coaxial and three-wire cables, examples may also be implemented using a triaxial cable. A triaxial cable includes a center conductor, a first shield (surrounding a first insulator over the center conductor), and a second shield (surrounding a second insulator over the first shield). In such configurations, the video signal may be carried over the center conductor and first shield, while the control signal may be sent over the second shield. Other configurations may also be used. Diagram 400A shows a triaxial connector in side view 402, perspective view 404, and front view 406 with the connector’s center contact and concentric dual shields.

FIG. 4B illustrates a cross-section view of a triaxial plug connector for a coaxial cable assembly with video and switch contacts, arranged in accordance with at least some embodiments described herein.

Diagram 400B shows details of the triaxial plug connector with triaxial cable 412, center conductor 416, first shield 418, and second shield 414 with insulators between them. As mentioned above, the video signal may be carried between the center conductor and the first shield, and the control signal from the switch may be carried over the first and second shields. Alternatively, the video signal may be carried over the first and second shields while the control signal may be carried over the center conductor and the first shield.

FIG. 4C illustrates side, perspective, and front views of a triaxial receptacle connector for a coaxial cable assembly with video and switch contacts, arranged in accordance with at least some embodiments described herein.

Diagram 400C shows a triaxial receptacle connector arranged to mate with the plug connector of FIG. 4A or similar ones in side view 422, perspective view 424, and front view 426 with the connector’s center contact and concentric dual shields. The receptacle triaxial connector may also include a round spring inside to provide enhanced electrical connectivity.

FIG. 4D illustrates a cross-section view of a triaxial receptacle connector for a coaxial cable assembly with video and switch contacts, arranged in accordance with at least some embodiments described herein.

Diagram 400D shows a cross-section view of the triaxial receptacle connector 402 with center conductor 436, first shield 440, and second shield / conductive body 434. The example configuration also includes a spring 432 for shield connectivity and an O-ring seal 438 for sealing the connector environmentally. As mentioned above, the video signal may be carried between the center conductor and the first shield, and the control signal from the switch may be carried over the first and second shields. Alternatively, the video signal may be carried over the first and second shields while the control signal may be carried over the center conductor and the first shield.

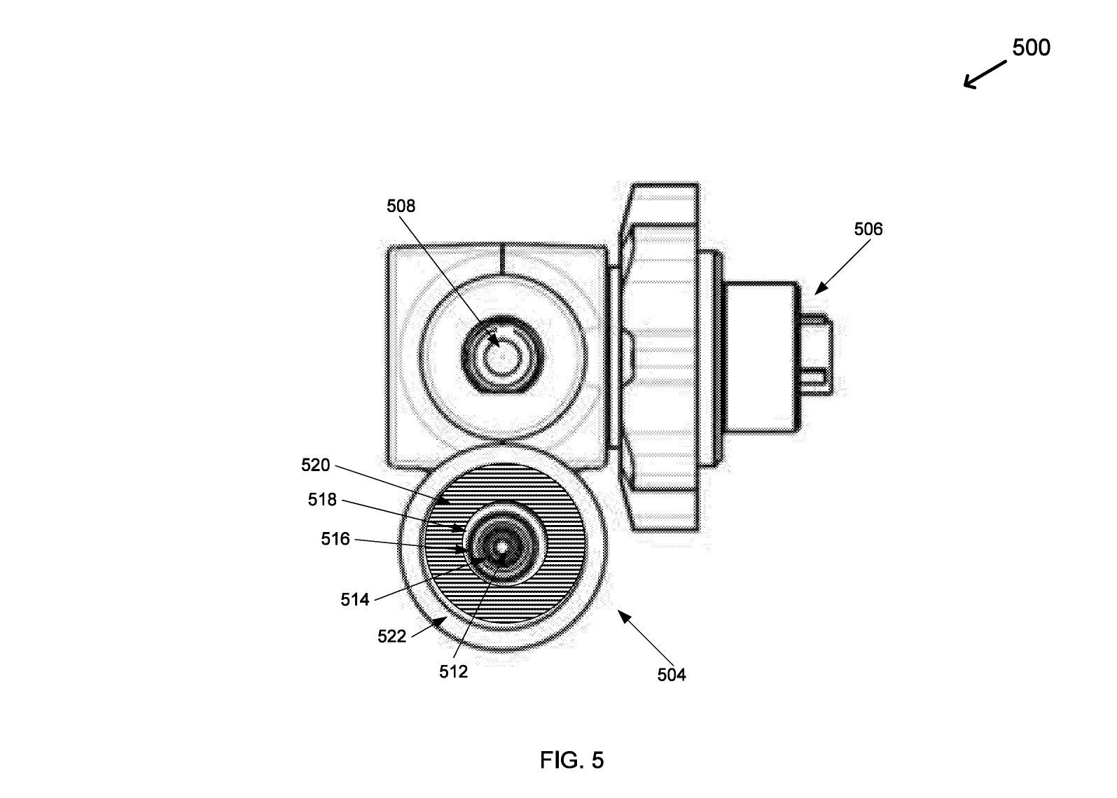

FIG. 5 illustrates the connectors and the switch of a coaxial cable assembly with video and switch contacts, arranged in accordance with at least some embodiments described herein.

Diagram 500 shows second coaxial connector 506, switch 508, and details of first coaxial connector 504 of a coaxial cable assembly according to examples. The first coaxial connector 504 may include a center conductor 512, first insulator 514, shield 516, second insulator 518, and conductive outer body 522, for example. A spring 520 may be used to provide enhanced shield connectivity. In some examples, the video signal may be transmitted over the shield 516 and conductive outer body 522, while the control signal may be transmitted over the center conductor 512.

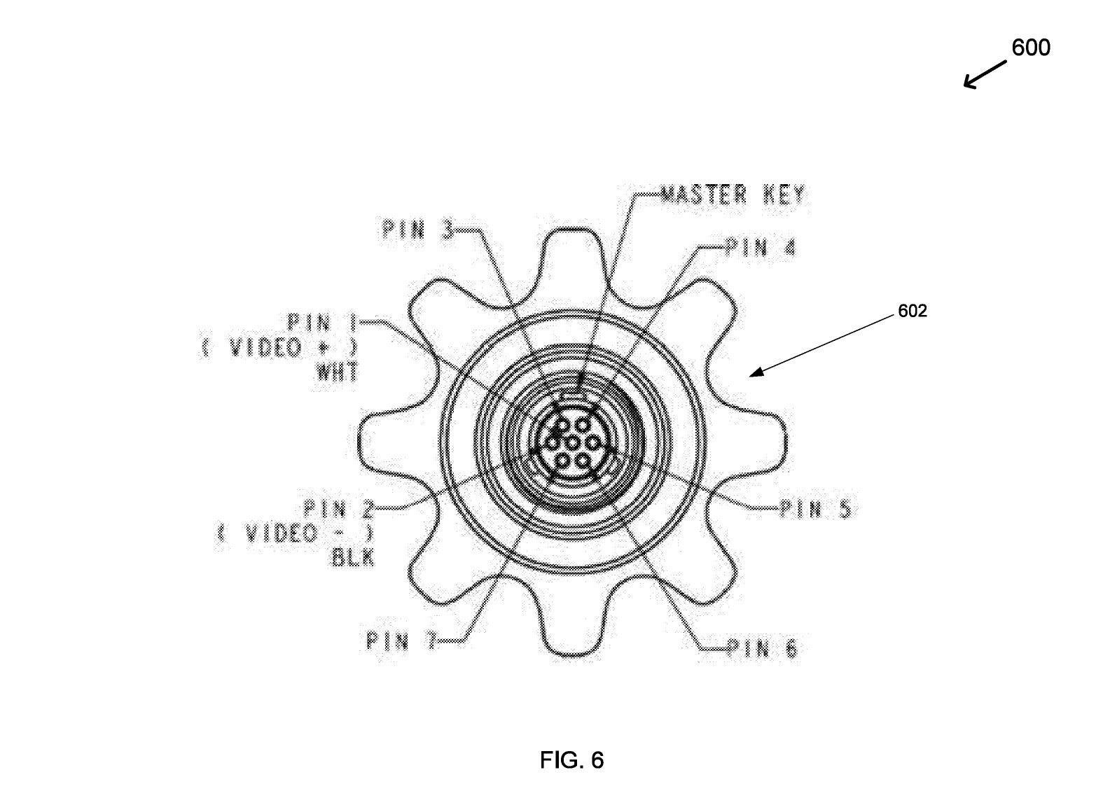

FIG. 6 illustrates a front view with contact layout of an example multi-pin connector that may be used with a coaxial cable assembly with video and switch contacts, arranged in accordance with at least some embodiments described herein.

As mentioned above, any type of coaxial connector may be used for the first or second connector. While FIG. 4A-4D provide an example of triaxial connector for video and control signals, diagram 600 shows the use of a different connector at the switch end of the coaxial cable assembly. For example, a 7-contact coaxial connector 602 may be used. In such a configuration, two of the contacts may be used for video signal, and one for control signal (e.g., enable/disable). The control contact may be coupled to a switch for transmitting the control signal.

According to some examples, a coaxial cable assembly may include a coaxial cable comprising three conductors; a first connector coupled to a first terminus of the coaxial cable comprising at least three contacts; and a second connector coupled to a second terminus of the coaxial cable comprising at least three contacts, where two of the three conductors and two of the at least three contacts of the first and second connectors are used to transmit a radio frequency (RF) signal, and one of the three conductors and one of the at least three contacts of the first and second connectors are used to transmit a control signal.

According to other examples, the RF signal is a video signal. The control signal is an enable/disable signal. The coaxial cable assembly may further comprise a control switch to provide the control signal. The control switch may be a toggle switch, a rocker switch, a push-button switch, or a touch switch. The coaxial cable may include a center conductor, a first insulator enveloping the center conductor, a shield enveloping the first insulator, a second insulator enveloping the shield, a conductive outer body enveloping the second insulator, and an outer insulator enveloping the conductive outer body; the RF signal may be transmitted over the shield and the conductive outer body, and the control signal may be transmitted over the center conductor.

According to further examples, the coaxial cable may include a center conductor, a first insulator enveloping the center conductor, a first shield enveloping the first insulator, a second insulator enveloping the first shield, a second shield enveloping the second insulator, and an outer insulator enveloping the second shield; the RF signal may be transmitted over the first shield and the second shield; and the control signal may be transmitted over the center conductor. The coaxial cable may include twisted pair of wires, a single wire, an insulator enveloping the twisted pair of wires and the single wire, a shield enveloping the insulator, and an outer insulator enveloping the shield; the RF signal may be transmitted over the twisted pair of wires; and the control signal may be transmitted over the single wire. The RF signal is digital or analog. The control signal is an end device detection signal.

According to some examples, a triaxial cable assembly may include a triaxial cable comprising a center conductor, a first shield, and a second shield; a first triaxial connector coupled to a first terminus of the triaxial cable comprising a center conductor, a first shield, and a second shield; a second triaxial connector coupled to a second terminus of the coaxial cable comprising a center conductor, a first shield, and a second shield; and a control switch. The first shield and the second shield of the triaxial cable, the first triaxial connector, and the second triaxial connector may be used to transmit a video signal, and the center conductor and one of the first and second shields of the triaxial cable, the first triaxial connector, and the second triaxial connector may be used to transmit a control signal from the control switch.

According to other examples, the control signal may be an enable/disable signal for a video capture or a video display device coupled to one of the first or second triaxial connectors. The control switch may be a toggle switch, a rocker switch, a push-button switch, or a touch switch. The video signal may be digital or analog.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

We claim:

1. A coaxial cable assembly comprising:
a coaxial cable comprising three conductors;
a first connector coupled to a first terminus of the coaxial cable comprising at least three contacts; and
a second connector coupled to a second terminus of the coaxial cable comprising at least three contacts, wherein
two of the three conductors and two of the at least three contacts of the first and second connectors are used to transmit a radio frequency (RF) signal, and
one of the three conductors and one of the at least three contacts of the first and second connectors are used to transmit a control signal.

2. The coaxial cable assembly of claim 1, wherein the RF signal is a video signal.

3. The coaxial cable assembly of claim 1, wherein the control signal is an enable/disable signal.

4. The coaxial cable assembly of claim 3, further comprising:
a control switch to provide the control signal.

5. The coaxial cable assembly of claim 4, wherein the control switch is one of a toggle switch, a rocker switch, a push-button switch, or a touch switch.

6. The coaxial cable assembly of claim 1, wherein
the coaxial cable includes a center conductor, a first insulator enveloping the center conductor, a shield enveloping the first insulator, a second insulator enveloping the shield, a conductive outer body enveloping the second insulator, and an outer insulator enveloping the conductive outer body,
the RF signal is transmitted over the shield and the conductive outer body, and
the control signal is transmitted over the center conductor.

7. The coaxial cable assembly of claim 1, wherein
the coaxial cable includes a center conductor, a first insulator enveloping the center conductor, a first shield enveloping the first insulator, a second insulator enveloping the first shield, a second shield enveloping the second insulator, and an outer insulator enveloping the second shield,
the RF signal is transmitted over the first shield and the second shield, and
the control signal is transmitted over the center conductor.

8. The coaxial cable assembly of claim 1, wherein
the coaxial cable includes twisted pair of wires, a single wire, an insulator enveloping the twisted pair of wires and the single wire, a shield enveloping the insulator, and an outer insulator enveloping the shield,
the RF signal is transmitted over the twisted pair of wires, and
the control signal is transmitted over the single wire.

9. The coaxial cable assembly of claim 1, wherein the RF signal is digital or analog.

10. The coaxial cable assembly of claim 1, wherein the control signal is an end device detection signal.

11. A triaxial cable assembly comprising:
a triaxial cable comprising a center conductor, a first shield, and a second shield;
a first triaxial connector coupled to a first terminus of the triaxial cable comprising a center conductor, a first shield, and a second shield;
a second triaxial connector coupled to a second terminus of the coaxial cable comprising a center conductor, a first shield, and a second shield; and
a control switch, wherein
the first shield and the second shield of the triaxial cable, the first triaxial connector, and the second triaxial connector are used to transmit a video signal, and
the center conductor and one of the first and second shields of the triaxial cable, the first triaxial connector, and the second triaxial connector are used to transmit a control signal from the control switch.

12. The triaxial cable assembly of claim 11, wherein the control signal is an enable/disable signal for a video capture or a video display device coupled to one of the first or second triaxial connectors.

13. The triaxial cable assembly of claim 11, wherein the control switch is one of a toggle switch, a rocker switch, a push-button switch, or a touch switch.

14. The triaxial cable assembly of claim 11, wherein the video signal is digital or analog.
